(19) United States
(12) Patent Application Publication
(10) Pub. No.: US 2006/0137516 A1
(43) Pub. Date: Jun. 29, 2006

(54) Sound searcher for finding sound media data of specific pattern type and method for operating the same

(75) Inventor: Jong-Yun Kim, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/317,206

(22) Filed: Dec. 23, 2005

(30) Foreign Application Priority Data
Dec. 24, 2004 (KR) P2004-111958

(51) Int. Cl. G10H 7/00

(52) U.S. Cl. 84/612

(57) ABSTRACT

Disclosed is a sound searcher for searching for sound media data of a specific pattern type in a sound reproduction terminal, the sound searcher includes a frequency analysis module for analyzing a frequency band of a sound media data to determine if the sound media data has a higher melody or a lower melody; a tempo analysis module for determining a tempo of the sound media data; a reference information selection module for receiving from the user the specific pattern type of a sound media data which a user want to find and registering the received specific pattern type; and a comparison module for determining if the analyzed frequency band and the determined tempo coincide with those of the registered specific pattern type, and outputting a comparison result.

### PRIORITY

This application claims to the benefit under 35 U.S.C. 119(a) of an application entitled “Sound Searcher for Finding Sound Media Data of Specific Pattern Type and Method for Operating the Same” filed in the Korean Intellectual Property Office on Dec. 24, 2004 and assigned Serial No. 2004-111958, the entire contents of which are incorporated herein by reference.

### BACKGROUND OF THE INVENTION

1. Field of the Invention

The present invention relates to an apparatus and a method for finding a sound media data of a specific pattern type, and more particularly to a sound searcher which is included in a sound reproduction terminal and can easily find a sound data of a specific pattern type sought by the user, and a method for operating the sound searcher.

2. Description of the Related Art

Multimedia is recognized as an important function in all portable devices. With the development of techniques to meet various user demands, people can easily get access to such a large number of multimedia files. Since sound media can be constructed more easily than video media and can be enjoyed at ease while a user is doing other work, the sound media files are widely used. Such sound media can be provided to a user in various types such as MPEG layer 3 (MP3), streaming radio broadcasting, or the like. For instance, a user can easily download MP3 music through the Internet to enjoy the MP3 music. Also, hundreds of Internet radio stations output sound media such as music. There exist a tremendous number of Internet radio stations.

### SUMMARY OF THE INVENTION

A problem in the above prior art arises since such a large number of sound media files and locations can cause the user inconvenience in that the user must search a large number of sound media on a one-by-one basis in order to select a song which the user wants to hear. For example, in a case in which the user wants to hear only fast-tempo dance songs from among one hundred MP3 music files stored in an MP3 player, if the user does not know the characteristics of the MP3 music files, the user must reproduce and listen to each of the music files for a predetermined time period (e.g., for about ten seconds) on a one-by-one basis before determining to listen to each music file.

Accordingly, the present invention has been made to solve at least the above-mentioned problems occurring in the prior art, and an object of the present invention is to provide an apparatus and a method for enabling the user to easily find desired sound media data from among large amounts of sound media data.

Another object of the present invention is to provide a method for finding sound media data under search conditions using frequency band analysis and tempo analysis.

To accomplish these objects, in accordance with one aspect of the present invention, there is provided a sound searcher for finding sound media data of a specific pattern type in a sound reproduction terminal, the sound searcher including a frequency analysis module for analyzing a frequency band of a sound media data to determine if the sound media data has a higher melody or a lower melody; a tempo analysis module for determining a tempo of the sound media data; a reference information selection module for receiving the specific pattern type of sound media data which a user want to find from the user and registering the received specific pattern type; and a comparison module for determining if the analyzed frequency band and the determined tempo coincide with those of the registered specific pattern type, and outputting a comparison result.

In accordance with another aspect of the present invention, there is provided a method for finding sound media data of a specific pattern type, the method including the steps of receiving and registering a pattern type of sound media data to be found; reading a specific sound media file and analyzing a frequency band and a tempo of a relevant sound media data; determining if the analyzed frequency band and tempo coincide with those of the registered pattern type and outputting the comparison result; and repeatedly performing the analyzing and comparison/outputting steps with respect to a plurality of sound media files.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a construction of a sound reproduction terminal according to an embodiment of the present invention;

FIG. 2A is a graph showing an analog output waveform of a specific sound media data;

FIG. 2B is a graph showing a frequency band of the specific sound media data; and

FIG. 3 is a flowchart illustrating a procedure for finding a sound media data of a specific pattern type according to an embodiment of the present invention.

### DETAILED DESCRIPTION OF THE PREFERRED EMBODIMENT

Hereinafter, a preferred embodiment of the present invention will be described with reference to the accompanying drawings. It is to be noted that the same elements are indicated with the same reference numerals throughout the drawings. In the following description of the embodiment of the present invention, a detailed description of known functions and configurations incorporated herein will be omitted when it may obscure the subject matter of the present invention. In addition, the terminology used in the description is defined in consideration of the function of corresponding components used in the present invention and may be varied according to users, operator's intention, or practices. Accordingly, the definition must be interpreted based on the overall content disclosed in the description.

Also, in the following description of the embodiments of the present invention, all terminals capable of reproducing music, which include an MPEG layer 3 player (MP3 player), an MP3 phone, an MP3 personal digital assistant (MP3 PDA), a music streaming terminal, an Internet radio streaming terminal, a personal computer (such as a desktop computer or a notebook computer), and the like, will be described as a “sound reproduction terminal”. Therefore, it will be understood that a sound reproduction terminal represents all terminals capable of reproducing music in the following description.

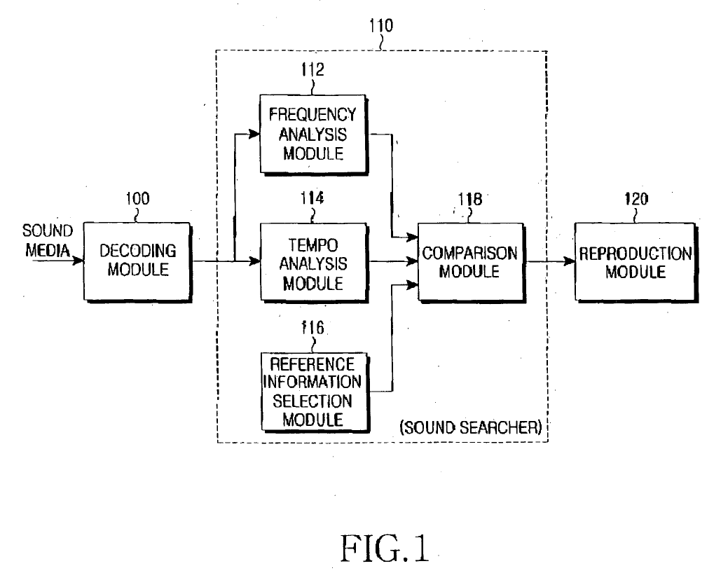

FIG. 1 is a block diagram illustrating a construction of a sound reproduction terminal according to an embodiment of the present invention. The sound reproduction terminal includes a decoding module 100, a reproduction module 120 and a sound searcher 110. The sound searcher 110 includes a frequency analysis module 112, a tempo analysis module 114, a reference information selection module 116, and a comparison module 118. The sound searcher 110 functions to search for sound media data of a specific pattern type according to a request of the user, by using the frequency analysis module 112, the tempo analysis module 114 and the reference information selection module 116.

The decoding module 100 decodes an input sound media data to output a sound media signal of an analog type. For example, when the decoding module 100 receives MP3 sound media data, the decoding module 100 outputs an analog signal by processing the received data according to an MP3 encoding algorithm. Similarly, when the decoding module 100 receives an Internet streaming radio broadcast, the decoding module 100 decodes the received steaming data, thereby outputting an analog signal.

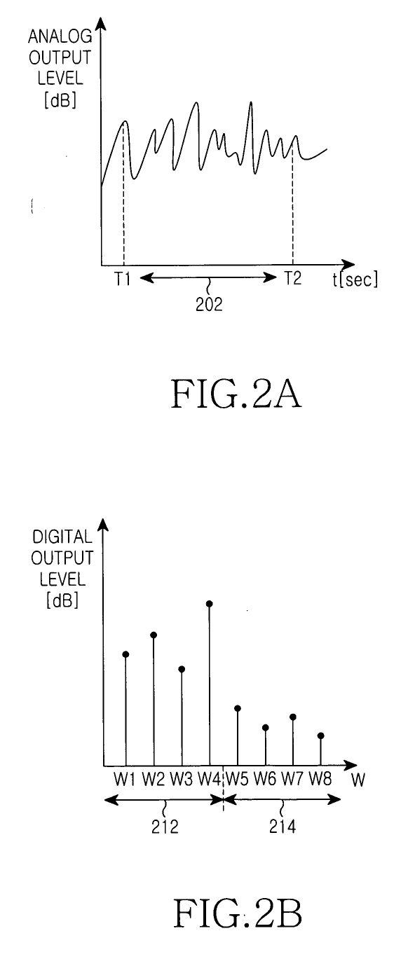

The frequency analysis module 112 receives a decoded analog signal, performs a frequency conversion process with respect to the received analog signal, and analyzes the frequency band of the received signal. Such a frequency conversion process represents a process of converting an input analog signal into their relevant frequency components by Fourier transform. For example, when an analog signal of a specific time period (from T1 to T2) 202 as shown in FIG. 2A is input to the frequency analysis module 112, the frequency analysis module 112 performs Fourier transform with respect to the input analog signal, thereby outputting frequency components as shown in FIG. 2B. In addition, the frequency analysis module 112 performs an analysis process of determining if a relevant media sound has a higher melody or a lower melody by analyzing the frequency band thereof, as well as the frequency conversion process. For example, in a frequency band converted from a specific media sound, when the output of a low-frequency band (W1, W2, W3 and W4) 212 are greater than the outputs of a high-frequency band (W5, W6, W7 and W8) 214 as shown in FIG. 2B, it can be understood that the relevant media sound has a low-frequency band, that is, is a sound with a lower melody.

The tempo analysis module 114 senses the quantity of the output change of an input analog signal every predetermined time interval and measures the tempo of a relevant song. For example, when the tempo analysis module 114 detects an average change quantity in output levels of output waveforms for the specific time period (from T1 to T2) 202 as shown in FIG. 2A and thus determines the detected average change quantity to be greater than a predetermined threshold value, the tempo analysis module 114 determines that the relevant song has a fast tempo. In contrast, when it is determined that the detected average change quantity is less than a predetermined threshold value, the tempo analysis module 114 determines that the relevant song has a slow tempo. Such an analysis result obtained by the tempo analysis module 114 is transmitted to the comparison module 118.

The reference information selection module 116 receives basic information of the sound media to be found from the user and stores the received basic information. The reference information includes information representing pattern types of sound media such as a song with a lower melody, a song with a higher melody, a fast-tempo song and a slow-tempo song. Therefore, the reference information selection module 116 may be requested to find sound media data having a song with a lower melody. Also, the reference information selection module 116 may be also requested to find sound media data which satisfies two conditions of pattern types, such as a song with a lower melody and a slow tempo. The reference information selection module 116 receives from the user reference information, which needs to find sound media data, as described above and transmits the received reference information to the comparison module 118, thereby enabling the comparison module 118 to find sound media data having a specific type sought by the user.

The comparison module 118 receives pitch information of a specific sound media data (that is, information about whether the specific sound media data is a song with a higher melody or a song with a lower melody) from the frequency analysis module 112, and simultaneously receives tempo information of the specific sound media data (that is, information about whether the specific sound media data is a fast-tempo song or a slow-tempo song) from the tempo analysis module 114. Then, the comparison module 118 compares the received pattern type of the specific sound media data with the pattern type registered in the reference information selection module 116, thereby determining if the two pattern types are identical.

TABLE 1
Reference information: “song with lower melody” and “slow-tempo song”

| | | | |
|---|---|---|---|
| Kind of | Information output | Information output | Compari- |
| Sound | from Frequency | from Tempo analysis | son |
| media data | analysis module | module | result |
| | [song with lower | [slow-tempo song/ | |
| | melody/song with | fast-tempo song] | |
| | higher melody] | | |
| 1st sound | song with lower melody | slow-tempo song | 1 (True) |
| media data | | | |
| 2nd sound | song with higher | slow-tempo song | 0 (False) |
| media data | melody | | |
| — | — | — | — |

For example, as described in Table 1, in the case in which reference information stored in the reference information selection module 116 is “song with lower melody” and “slow-tempo song”, when information output from the frequency analysis module 112 is “song with lower melody” and information output from the tempo analysis module 114 is “slow-tempo song”, as described as the analysis result with respect to the first sound media data, the comparison module 118 outputs a high level “1” representing ‘True’ to the reproduction module 120. In contrast, as described as the analysis result with respect to the second sound media data, when information output from the frequency analysis module 112 is “song with higher melody”, the comparison module 118 outputs a low level “0” representing ‘False’ to the reproduction module 120 because the pattern type of the second sound media data is not identical to the pattern type of “song with lower melody” registered in the reference information selection module 116.

The reproduction module 120 continues to reproduce a sound media data only when the analysis result of the relevant sound media data represents the true value “1”. In some cases, when the reproduction module 120 receives the true value “1”, the reproduction module 120 may display the fact that a song desired by the user has been found, together with the file name of relevant sound media data. That is, when sound media data requested by the user is detected from a plurality of sound media data, the file names of the detected data may be displayed as a list. Then, the user can select and playback a specific sound media file from among the sound media files displayed as a list.

According to an embodiment of the present invention, information of classification criteria (which include judgment criteria for determining if a song has a lower melody or a higher melody, and if a song has a slow tempo or a fast tempo, in the frequency analysis module and the tempo analysis module, respectively) may be input directly by the user. For example, the user may set classification criteria, in such a manner that the song of a sound media data having at least 100 beats per minute is classified as a fast-tempo song and the song of a sound media data having a frequency band equal to or greater than 10 kHz is classified as a song with a higher melody. As described above, since users can directly set the classification criteria, it is possible that the user extracts songs with a lower or higher melody and a slow or fast tempo from among a large number of sound media data according to the users' tastes.

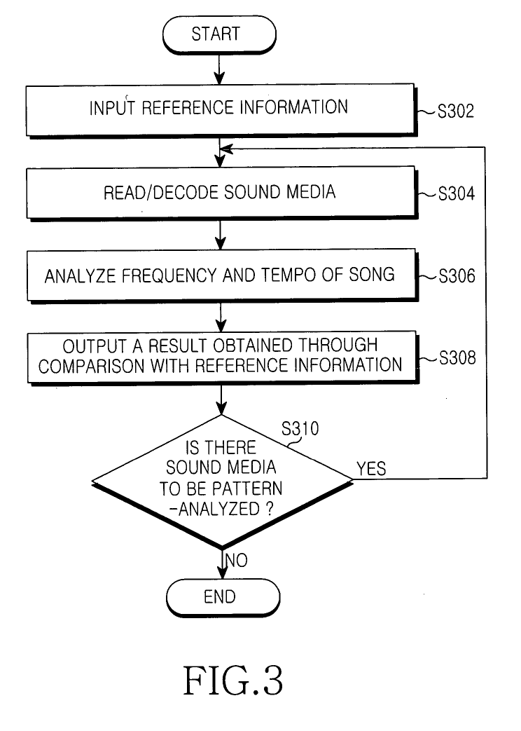

FIG. 3 is a flowchart illustrating a procedure for finding a sound media data desired by the user according to an embodiment of the present invention. First, the sound reproduction terminal receives reference information from the user in step 302. As described with reference to FIG. 1, the reference information includes pattern types which are criteria for finding sound media data, such as a song with a lower melody or a higher melody and/or a fast-tempo or slow-tempo song. The user inputs a pattern type of sound media, which the user want to find, into the sound reproduction terminal, so that the sound reproduction terminal can find sound media data according to input criteria for a desired pattern type. After the reference information has been input, the procedure proceeds to a step of analyzing a pattern of each sound media data stored in the sound reproduction terminal. To this end, the sound reproduction terminal first reads the sound media data to be searched on a one-by-one and decodes each read data in step 304. In step 306, an analog signal generated through step 304 is analyzed, thereby determining if the read data is a song with a higher melody or a lower melody and/or if the read data is a fast-tempo or a slow-tempo song. Each analysis result obtained in step 306 is transmitted to the comparison module. In step 308, the comparison module compares the analysis result with the registered pattern type and outputs either a true value or a false value to the reproduction module according to the result of the comparison, that is, according to whether or not the analysis result is identical to the registered pattern type. Thereafter, it is determined if there is any other sound media data to be searched in step 310. The pattern type analysis procedure returns to step 304 when there is other sound media data to be searched, and the pattern type analysis procedure ends when there is no sound media data to be searched. The sound media data extracted through the steps may be displayed as a list so that the user can select a sound media data to be reproduced. Also, the present invention may be realized in such a manner that the extracted sound media data are reproduced in sequence.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A sound searcher for finding sound media data of a specific pattern type in a sound reproduction terminal, the sound searcher comprising:
a frequency analysis module for analyzing a frequency band of sound media data to determine if the sound media data has a high or low melody;
a tempo analysis module for determining a tempo of the sound media data;
a reference information selection module for receiving from a user the specific pattern type of sound media data to be searched for and registering the received specific pattern type; and
a comparison module for determining if the analyzed frequency band and the determined tempo coincide with those of the registered specific pattern type, and outputting a comparison result.

2. The sound searcher as claimed in claim 1, wherein the sound reproduction terminal further comprises a decoding module, which decodes compressed sound media data and outputs an analog signal.

3. The sound searcher as claimed in claim 1, wherein the sound reproduction terminal further comprises a reproduction module, which reproduces sound media data when a frequency band and a tempo obtained through analysis of the sound media data coincide with those of the registered specific pattern type.

4. The sound searcher as claimed in claim 1, wherein the sound reproduction terminal displays a file name of sound media data when a frequency band and a tempo obtained through analysis of the sound media data coincide with those of the registered specific pattern type.

5. The sound searcher as claimed in claim 1, wherein the frequency analysis module receives and frequency-converts a sound media data of an analog waveform.

6. The sound searcher as claimed in claim 1, wherein the pattern type includes a song with at least one of a high melody, a low melody, a fast-tempo, and a slow-tempo.

7. The sound searcher as claimed in claim 6, wherein judgment criteria for a song with a higher/lower melody and a fast-tempo/slow-tempo song are input by the user.

8. The sound searcher as claimed in claim 1, wherein the comparison module outputs a true value when the analyzed frequency band and tempo coincide with those of the registered pattern type, and outputs a false value when the analyzed frequency band and tempo are not identical to the registered pattern type.

9. A method for finding a sound media data of a specific pattern type, the method comprising the steps of:
receiving and registering a pattern type of sound media data to be search for;
reading a specific sound media file and analyzing a frequency band and a tempo of a relevant sound media data;
determining if the analyzed frequency band and tempo coincide with those of the registered pattern type and outputting the comparison result; and
repeating the analyzing and comparison/outputting steps with respect to other sound media files.
